(19) United States
(12) Patent Application Publication
(10) Pub. No.: US 2002/0125367 A1
(43) Pub. Date: Sep. 12, 2002

(54) Combination fixed and rotating wing aircraft, land vehicle and water craft

(76) Inventor: Norman Don Killingsworth, Costa Mesa, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 10/096,747

(22) Filed: Mar. 12, 2002

Related U.S. Application Data
(60) Provisional application No. 60/274,982, filed on Mar. 12, 2001.

(51) Int. Cl. B64C 27/00; B64C 15/00; B64C 27/82

(52) U.S. Cl. 244/17.11; 244/51

(57) ABSTRACT

A vehicular apparatus is mounted within a seaworthy hull and has a pair of swept wings extending from sides amidships thereof. A canard wing is deck mounted forward amidships and a pair of helicopter rotor blades, are mounted above the deck of the hull and are angled such that they are able to rotate without mutual interference. A pair of vertical stabilizers support a horizontal stabilizer and a pair of spaced apart jet engines for providing forward thrust to the apparatus through the air. Marine engines are mounted within the hull astern for driving a pair of marine screws for providing forward thrust to the apparatus through the water. A set of wheels and wheel driving power means are enabled for driving the apparatus in a forward direction on land.

This application claims the priority date of a prior filed provisional patent application filed with the United States Patent & Trademark Office on Mar. 12, 2001 as Ser. No. 60/274,982 and which discloses the same invention as herein claimed.

### BACKGROUND OF THE INVENTION

1. Field of the Invention

This invention relates generally to aircraft and water craft and more particularly to a land amphibian convertible vehicle able to move through both the water and air as well as to move across firm surfaces.

2. Description of Related Art

The prior art teaches seaworthy hulls for small water craft with marine power drives aft within the hull. The prior art also teaches fixed wing craft having jet propulsion engines mounted for driving such craft through the air. Also, the prior art teaches rotor driven craft such as helicopters that are able to operate from a fixed landing position with vertical and horizontal maneuvers. Finally, the prior art teaches wheel driven craft enabled for rolling on solid ground such as automobiles and trucks. These vehicles are well known in the art. However, the prior art does not teach a single vehicle capable of all of the foregoing. The present invention fulfills these needs and provides further related advantages as described in the following summary.

### SUMMARY OF THE INVENTION

The present invention teaches certain benefits in construction and use which give rise to the objectives described below.

The present invention is a combination amphibian, helicopter, gyroplane, sea plane, patrol boat and landing craft. The craft is able to take-off vertically and operate as a helicopter. It is designed to fly at a speed of 260 miles per hour as a gyroplane. It may be converted to a helicopter while in flight. As a water craft it is capable of moving at up to 80 miles per hour as an off-shore ocean racer and may take-off and land on water. It is able to move silently by electrical power. It provides accommodations for seven personnel plus two crew. This craft is light enough to land and to be stored on most military ships, large enough to launch a navy seal inflatable, sea-worthy enough to be water launched and retrieved as a boat from an amphibian or a converted helicopter carrier ship. It is also heavy enough and strong enough to carry light ordinance as will be described. Specifically, the invention is a vehicular apparatus mounted within a seaworthy hull and has a pair of swept wings extending from sides amidships thereof. A canard wing is deck mounted forward amidships and a pair of helicopter rotor blades, are mounted above the deck of the hull and are angled such that they are able to rotate without mutual interference. A pair of vertical stabilizers support a horizontal stabilizer and a pair of spaced apart jet engines for providing forward thrust to the apparatus through the air. Marine engines are mounted within the hull astern for driving a pair of marine screws for providing forward thrust to the apparatus through the water. A set of wheels and wheel driving power means are enabled for driving the apparatus in a forward direction on land.

A primary objective of the present invention is to provide an apparatus and method of use of such apparatus that provides advantages not taught by the prior art.

Another objective is to provide such an invention capable of traveling on land, water or through the air.

A further objective is to provide such an invention capable of fixed wing and helicopter flight.

A still further objective is to provide such an invention capable of stealth operations.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

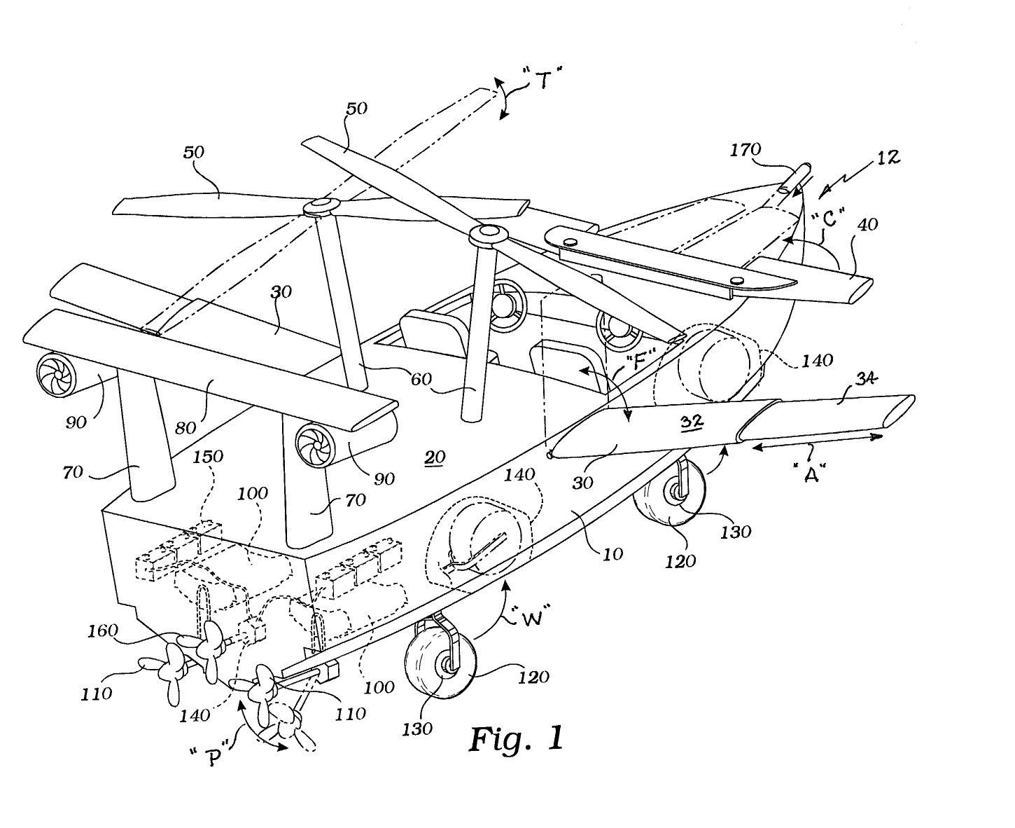

The accompanying drawing illustrates the present invention. In such drawing FIG. 1 is a perspective view of the preferred embodiment of the invention showing the several features and adaptations.

### DETAILED DESCRIPTION OF THE INVENTION

The above described drawing figures illustrate the invention in at least one of its preferred embodiments, which is further defined in detail in the following description.

The present invention is a vehicular apparatus comprising a seaworthy hull 10 preferably of a light and strong material such as a composite, covered by a deck 20 of similar material, and providing a pair of swept aircraft lift wings 30 capable of providing dynamic lift at relatively low air speeds, and extending from sides amidships thereof. Construction of the hull 10, deck 20 and wings 30 are well known in the art. A canard wing 40 is deck mounted forward amidships. Such a wing 40 is well known in the art. A pair of helicopter rotor blades 50 are each mounted on one of a pair of drive assemblies 60 extending above the deck 20 and are angled outwardly, one to port and one to starboard such that the pair of rotor blades are able to rotate without mutual interference. This is clearly shown in FIG. 1. Such blades 50, drive assemblies 60 and the powered means to drive and control them is well known in the art. The helicopter rotor blade drive assemblies are adapted for tilting the helicopter rotor blades to a forward angle of approximately seven and one-half degrees and also to a reward angle of approximately seven and one-half degrees. This tilt is shown in the phantom position of the port rotor blade 50 by arrow “T.” Such tilt mechanisms are well known in the art and enable a conventional helicopter to develop forward thrust. However, rearward tilting, as shown by arrow “T”, is considered a novelty of the present invention and allows the apparatus to fly at relatively high speed when the rotor blades are in the rearward tilted position and is flying as a gyrocopter.

A pair of aircraft type vertical stabilizers 70 extends upwardly from the deck 20 astern and support an aircraft type horizontal stabilizer 80. A pair of spaced apart jet engines 90 are mounted on the horizontal stabilizer 80 for providing forward thrust to the apparatus through the air. Such stabilizers 70, 80 and engines 90 are well known in the art, and the means to mount them and control them are well known as well. A pair of marine engines 100 are mounted within the hull 10 astern and are enabled for driving a pair of marine screws 110 which are positioned, as shown in FIGS. 1 and 2, for providing forward thrust to the apparatus through the water. The screws 110 are enabled for adjustable pitch angle as shown by arrow “P” in the figure. Such marine power and drives are very well known in the art. A set of wheels 120 are driven by a wheel driving power means 130. Means 130 is preferably a motor mounted as part of and within the wheels with tires mounted on a rotator portion of means 130, so as to be enabled for driving the apparatus in a forward direction on land, and this method of propulsion is very well known in the art. The set of wheels 120 are adapted, as shown in FIG. 1, for being positioned between retracted positions in bays 140 formed in the hull 10 and extended positions extending downward from the hull 10 in positions for supporting the apparatus on a firm surface such as a road or other land surface and this is shown by arrow “W”. The servomechanisms necessary for retracting the wheels 120 is very well known in the aircraft industry. The wheel driving power means 130 is enabled for steering the apparatus when the wheels 120 on one side of the hull 10 are driven in a backward going direction or are set to neutral, while the wheels on the other side of the hull 10 are driven in a forward going direction.

Preferably, the swept wings 30 each includes a main wing portion 32 and a telescoping wing portion 34 movable between a retracted position stored within the main wing portion 32 and an extended position linearly extensive from the main wing portion 32 and this is shown by arrow “A”. The means for providing movement of one wing segment within a second is well known in the art. The swept wings 30 are enabled for being positioned between a dihedral angle position extensive outwardly from the sides of the hull 10, as shown in solid line, and a vertical position, as shown in phantom line and is clear from arrow “F”. The movement of the wings 30 from an operational position to a stored uplifted position is well known in the types of fighter craft used aboard aircraft carriers by the United States Navy armed forces.

The canard wing 40 preferably has rotatable portions mounted for movement between a cross-ships position, shown in solid lines in the figure, and a position aligned axially with the hull 10 as can be readily seen in FIG. 1 shown in phantom line outline and as depicted by arrow ‘C”. The servomechanisms used to accomplish this are well known in the art.

An electric motor 140 is mounted and positioned within the hull 10 and is adapted with an electrical power source 150, preferably lead-acid batteries, and with a further marine screw 160 for driving the apparatus forward through the water silently. The source 150 is also used to power the driving power means 130, i.e., electric motors which make up the primary structural portion of the wheels 120.

A video imaging system 170, of any type well known in the art, is mounted in the bow 12 of the hull 10 and is mechanized to be positionable between a retracted position within the hull 10 and an extending position, shown in the figure, extending from, and above the deck 20. The mechanization of such a video system 170 is well known in the art especially in the film industry.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A vehicular apparatus comprising: a seaworthy hull with a pair of swept wings extending from sides amidships thereof and a canard wing deck mounted forward amidships; a pair of helicopter rotor blades, each mounted on a drive assembly extending above a deck of the hull and angled; one to port and one to starboard such that the pair of rotor blades are able to rotate without mutual interference; a pair of vertical stabilizers extending upwardly from the deck astern, the vertical stabilizers supporting a horizontal stabilizer thereon, a pair of spaced apart jet engines mounted on the horizontal stabilizer for providing forward thrust to the apparatus through the air, a pair of marine engines mounted within the hull astern and enabled for driving a pair of screws positioned for providing forward thrust to the apparatus through the water; and a set of wheels and wheel driving power means enabled for driving the apparatus in a forward direction, the set of wheels adapted for being positioned between a retracted position in bays formed in the hull and an extended position extending downward from the hull in positions for supporting the apparatus on a firm surface, the wheel driving power means enabled for steering the apparatus.

2. The apparatus of claim 1 wherein each of the swept wings includes a main wing portion and a telescoping wing portion movable between a retracted position stored within the main wing portion and an extended position linearly extensive from the main wing portion.

3. The apparatus of claim 2 wherein the swept wings are enable for being positioned between a dihedral angle extensive outwardly from the sides of the hull and a vertical position.

4. The apparatus of claim 1 wherein the canard wing is rotatably mounted for movement between a cross-ships position and a position aligned axially with the hull.

5. The apparatus of claim 1 further comprising an electric motor positioned within the hull and adapted with an electrical power source and a further screw for driving the apparatus forward through the water.

6. The apparatus of claim 1 further comprising a video imaging system mounted in the bow of the hull and positionable between a retracted position within the hull and an extending position extending from and above the deck.

7. The apparatus of claim 1 wherein the helicopter rotor blade drive assemblies are adapted for tilting the helicopter rotor blades to a forward angle of approximately seven and one-half degrees and also to a reward angle of approximately seven and one-half degrees.
